(19) United States
(12) Patent Application Publication
(10) Pub. No.: US 2013/0208589 A1
(43) Pub. Date: Aug. 15, 2013

(54) METHOD AND SINGLE RADIO STATION FOR MANAGING STATION THROUGHPUTS FROM A WIRELESS MULTIPLE ACCESS POINTS BACKHAUL

(71) Applicant: TELEFONICA S.A., (US)

(72) Inventors: Alberto LOPEZ TOLEDO, Madrid (ES); Eduard GOMA LLAIRO, Madrid (ES); Pablo RODRIGUEZ, Madrid (ES); Domenico GIUSTINIANO, Madrid (ES)

(73) Assignee: TELEFONICA S.A., Madrid (ES)

(21) Appl. No.: 13/838,067

(22) Filed: Mar. 15, 2013

Related U.S. Application Data
(63) Continuation of application No. PCT/EP2011/004633, filed on Sep. 15, 2011.

(51) Int. Cl. H04W 72/08; H04J 3/16

(52) U.S. Cl. CPC H04W 72/087; H04J 3/1694
USPC 370/230; 370/336; 370/330; 370/252

(57) ABSTRACT

Method and single radio station for managing station throughputs from a wireless multiple access points backhaul. The method comprises using a single radio interface per station to connect stations to one or more access points (AP₁, AP₂, AP₃), and scheduling the throughput there for by determining a throughput request Tᵢₖ for any station (k) to an access point (APᵢ), based on a previously received or requested throughput \hat{T}ᵢₖ , and calculating a corresponding duty cycle fᵢₖ during which said station (k) needs to connect to said access point (APᵢ) to receive said requested throughput Tᵢₖ. The single radio station is arranged for performing the scheduling and parameter estimation of the method and communicating means for connecting any station (k) to an access point (APᵢ) according to the obtained scheduling.

### CROSS REFERENCE TO RELATED APPLICATIONS

This application is a continuation application of International Application No. PCT/EP2011/004633, filed Sep. 15, 2011, which claims priority to U.S. provisional application 61/383,574 filed Sep. 16, 2010, the disclosures of which are incorporated by reference herein in their entirety.

### FIELD OF THE ART

The present invention generally relates, in a first aspect, to a method for managing station throughputs from a wireless multiple access points backhaul, comprising using a single radio interface per station and scheduling the throughput there for, and more particularly to a method comprising performing said scheduling by taking into account previous received or requested throughputs for calculating time to be spent connected to each access point.

The method of the invention provides a fair aggregation of wireless LAN backhauls.

A second aspect of the invention concerns to a single radio station arranged for implementing the method of the first aspect.

### PRIOR STATE OF THE ART

In urban environments, residential users can potentially see multiple 802.11 APs in range with high quality [1], usually connected to broadband links. As the speeds of 802.11 WLAN are typically an order of magnitude higher than those of standard broadband connections one can use a single 802.11 wireless card to aggregate the bandwidth of multiple AP backhauls in range by virtualizing the card and cycling over the APs in a TDMA fashion.

In that scenario, using an aggregation scheme like FatVAP [2], where stations greedily maximize their individual throughput, may lead to severe unfair situations. Fairness is important because it can impact individual users' performance and reduce its applicability on a commercial setting. For example, a station that is unluckily located in an area with only one AP in range, can see its throughput significantly lowered by other stations sharing the same AP, even if those stations could get spare bandwidth from other APs. This is what herein is called topology unfairness. Providing a fair distribution of throughput even in such heterogeneous situations is crucial to maintain a certain level of service across all users. Without some form of fairness, the perceived value of the system is severely reduced, and users will not participate.

Other unfairness situations also exist. For instance, stations using applications with many TCP flows, such as P2P, can severely affect the performance of other stations running single-flow applications such as Web downloads. This situation is called here flow distribution unfairness, and can result in some stations obtaining much less throughput than what they would obtain without sharing.

Another example of unfairness could appear in a scenario where customers with different subscription plans share their broadband links. For instance, fast broadband customers (that pay more than slow broadband customers), should obtain a greater share of the spare backhaul capacity. If this is not enforced, customers may be inclined to buy slower (and cheaper) broadband connections and free-ride on their neighbours' spare bandwidth. This is a typical “tragedy of the commons” example: people tend to over-exploit the shared resource by minimizing their contribution (their broadband contracted speed), ultimately cannibalizing the shared resource. Moreover, this eliminates the incentive of an ISP to deploy the sharing system, because it threats its business model. Henceforth this billing will be called unfairness.

The above fairness scenarios can have a dramatic impact on the deployability of various multi-AP aggregation schemes including: a) community-based sharing schemes (e.g. FON [3], Wi-Sh [4]), b) Telco-managed sharing schemes where residential Wi-Fi gateways are shared across all users that subscribe to the service, and c) commercial AP aggregation scenarios (e.g. airport hotspots). Moreover, existing aggregation schemes such as FatVAP [2] and VirtualWiFi [5] are not designed with fairness in mind, and hence cannot be directly applied to the above scenarios.

Next, different kinds of unfairness, as understood in relation to the present invention, are stated and described in relation to the above mentioned known schemes, with reference to FIGS. 1 and 2, considering the scenario depicted by FIG. 3, which shows a multi-AP backhaul aggregation where single-radio 802.11 stations simultaneously connect to one or more APs. In this scenario, the AP backhaul bandwidth of the APs is shared among the stations.

Topology unfairness: Consider the experiment depicted in FIG. 1(a) (all the tests and validations described herein are performed experimentally on realistic scenarios), where stations A and B share 3 APs, each of them having a 5 Mbps backhaul. The wireless speed from each station to the three APs is 20 Mbps. However, because of its location, station B has only two APs in range, while station A can reliably connect to all the APs. A fair distribution of the aggregated AP backhaul would assign half of the backhaul capacity—7.5 Mbps—to each station. Using a throughput maximization scheme as in [2], station B obtains 5 Mbps, almost half of the throughput of station A, which obtains more than 9 Mbps due to its better location (FIG. 1(b)).

Flow distribution unfairness: Consider now the experiment in FIG. 2(a), where stations A and B connect to two APs with 5 Mbps backhauls. The wireless speed between the stations and the APs is 20 Mbps. Station B starts one download per AP, each using a single TCP flow. Station A, on the other hand, starts one download per AP, but each using 10 TCP flows. The experiment is set up to guarantee that the flows are not limited by the end-to-end connection, i.e. the bottleneck is in the AP backhaul. In this scenario, a fair distribution of the AP backhaul would result in each station receiving 5 Mbps. However, if the stations aim to maximize their individual aggregate throughput without taking fairness into account as in [2], the result is a gross unfair distribution of the bandwidth, with station A receiving almost 9 Mbps, most of the aggregated bandwidth, while station B receives less than 1 Mbps (FIG. 2(b)). A similar scenario could be shown for the case of billing unfairness.

FIG. 1 and FIG. 2 clearly illustrate the need to provide a fairness mechanism for the multi-AP backhaul aggregation scheme. However, it is important to agree on some notion of fairness, since each one could have different design implications and trade-offs.

In recent years Wi-Fi communities have attracted the attention of both the research community and the wireless industry because of the uptake of WLAN in residential areas. In this direction [3, 4, 18] propose to allow members of the communities to share the backhaul bandwidth of their WLAN APs. Among those, Wi-Sh [4] discusses the fairness problems that can arise from sharing resources. However, it does not consider the use of multiple APs to aggregate their backhaul bandwidth.

Backhaul bandwidth aggregation has been explored in [19, 20], where stations connect to their home APs via Ethernet and to the remote APs using WLAN. However, they do not connect to multiple APs via Wi-Fi, so the number of APs they can aggregate is limited by the number of physical interfaces (Ethernet and Wi-Fi) available at the stations.

The idea of connecting to multiple APs through a single radio was first shown in VirtualWiFi [5]. The authors rely on the WLAN standard power saving (PS) mode to switch among different Wi-Fi nodes in time division. Switching among Wi-Fi nodes is transparent to the applications, but at a high cost in time (30-600 ms). In fact, VirtualWiFi implements the code on top of the driver card with a MAC instance for connection.

Within the problem of single radio AP backhaul aggregation, the closest work is FatVAP [2]. The authors introduce a scheduler to select the percentage of time to spend on each AP to maximize the aggregate throughput at each station. However it [2] has a limited focus because it does not resolve the unfairness across stations, and it only considers stations connected to (strictly) more than one AP. Furthermore, the local throughput maximization approach in [2] cannot be extended in order to take into account priority-based per station fairness.

Among other work, [21] introduces a support for a seamless hand-off between WLAN APs. In [15], standard solutions have been exploited to increase the aggregate throughput observed by a single station with respect to the design in [2, 5, 21]. However, these works do not consider the problem of fairness.

Link-alike [22] tackles the problem of minimizing the uplink total transfer time via multiple wireless links. However, the solution requires cooperation among the APs, with 802.11 APs transmitting and receiving at the same radio-frequency, and a custom TCP protocol over the wireless link.

Several tools have been designed to estimate the available bandwidth along a network path. However, these tools typically send active probes along a path and/or require a cooperative implementation at both the sender and receiver [23, 24].

There is little work on non-cooperative estimation of the ADSL available bandwidth. Most notably ABwProbe [25] and FAB-Probe [26] rely on the asymmetry of the ADSL downlink capacity to send TCP ACK packets of different sizes and receive small TCP RST packets from the TCP client. Since the TCP RST is at fixed length, they cannot estimate the available bandwidth from the client-side.

Moreover, the estimation of the wireless capacity has been studied with different levels of accuracy (see e.g. [2, 27]).

It is known in the field some methods for connecting a single-radio station to multiples APs. For instance [28] discloses a similar method to the one provided by the present invention, even though it do not provide a fair sharing implementation of the overall backhaul bandwidth when performing aggregation.

On another hand there exist also related methods trying to achieve said fair sharing, for instance [29] where it schedules the traffic proportionally according to obtainable bandwidth and assigns the flows to the AP trying a fair share, and [30] which discloses a MaxSum utility based packet scheduler which delivers a fairer overall service to VoIP clients in terms of quality. Being this quality calculated based on previous factor R.

### DESCRIPTION OF THE INVENTION

It is necessary to offer an alternative to the state of the art which covers the gaps found therein, particularly those found in the above named as closest work FatVAP [2] including those regarding the scheduling there provided.

To that end, the present invention provides, in a first aspect, a method for managing station throughputs from a wireless multiple access points backhaul, comprising using a single radio interface per station and scheduling the throughput there for.

On contrary to the known proposals, and particularly differently from [2], the method of the first aspect of the invention, in a characteristic manner, is applied to connect stations to one or more access points and comprises performing said scheduling by determining a throughput request Tᵢₖ for any station to an access point, based on a previously received or requested throughput, and calculating a corresponding duty cycle during which said station needs to connect to said access point to receive said requested throughput Tᵢₖ.

As per an embodiment, the method comprises calculating said duty cycle fᵢₖ during which said station connects to said access point to receive said requested throughput Tᵢₖ by means of the next expression: fᵢₖ=Tᵢₖ/ωᵢₖ, where ωᵢₖ is the wireless capacity (backhaul bandwidth) at which said station can receive from said access point.

The method of the first aspect of the invention comprises, for an embodiment, estimating several parameters needed for calculating the mentioned duty cycle, or a corrected one, as described according to claims 12 to 21, and in a subsequent section regarding the detailed description of several embodiments.

Other embodiments of the method of the first aspect of the invention are disclosed by claims 3 to 11 and also in said subsequent section.

A second aspect of the invention concerns to a single radio station for managing station throughputs from a wireless multiple access points backhaul, which comprises processing means implementing algorithms for performing the scheduling and parameter estimation of the method of the first aspect of the invention, and communicating means for connecting any station to one or more access points according to the obtained scheduling.

The terms “single radio station” must not be understood too restrictively, as it refers to: stations which really have only one radio interface and also stations having more than one radio interface but using only one of them to connect to the access points as explained above referring to the method of the first aspect of the invention. Another example of “single radio station” is an access point with more than one radio but using only one of them to connect as a client to the access points in coverage range as explained above referring to the method of the first aspect of the invention.

Next the single radio station of the second aspect of the invention and the one used by the method of the first aspect will also be called as THEMIS, as that is the name given to a prototype built by the inventors implementing said station.

THEMIS fairly aggregates the backhaul bandwidths of several APs, and has been extensively evaluated in controlled scenarios, as will be shown in a posterior section, giving results that unequivocally show that it provides a fair distribution of the available backhaul bandwidth among users.

Compared to [2], THEMIS fairly aggregates the AP backhaul bandwidth among the different THEMIS stations, irrespectively of their location, link quality and number of APs they have in range. Moreover, THEMIS is able to adapt to different fairness objectives in order to accommodate the different scenarios discussed in this invention, and it achieves this in a completely distributed manner. Finally, THEMIS implementation of the single-radio multi-AP TDMA access is improved compared to [2, 5], reducing the frequency switching overhead and increasing the accuracy when selecting the amount of time that the station connects to the different APs. This results in a more efficient operation and increased throughput.

The experimental evaluation, which will be described later, has demonstrated the robustness of THEMIS in realistic scenarios, under MAC contention, adaptive PHY rates and performance anomaly.

Regarding the bandwidth estimation, on contrary to [25] and [26] which due to the fact that they use TCP RST packets and these are at fixed length, they cannot estimate the available bandwidth from the client-side, THEMIS allows such a client/side bandwidth estimation.

### BRIEF DESCRIPTION OF THE DRAWINGS

The previous and other advantages and features will be more fully understood from the following detailed description of embodiments, with reference to the attached drawings (some of which have already been described in the Prior State of the Art section), which must be considered in an illustrative and non-limiting manner, in which:

FIG. 1 shows the deployment (a) and unfair results (b) of the experiment described above related to the topology unfairness for users with different AP connectivity, using the scheme of [2];

FIG. 2 shows the deployment (a) and unfair results (b) of the experiment described above related to the flow distribution unfairness for users with different number of flows, also using the scheme of [2];

FIG. 3 shows a Multi-AP aggregation scenario;

FIG. 4 illustrates a Time-Division Access to multiple APs used for communicating the single radio station, or THEMIS, separately to said APs at different frequencies, according to an embodiment of the method of the invention;

FIG. 5 shows data packets sent by APᵢ to any station from which THEMIS estimates the utilization rate of the AP backhaul, and two consecutive received packets sent by the AP in saturation, from which THEMIS estimates the wireless capacity;

FIG. 6 illustrates a queue management performed by the single radio station according to an embodiment of the method of the invention;

FIG. 7 is a graph showing, by means of four waves, an estimation of the AP backhaul utilization performed at three stations according to the method of the first aspect of the invention, for an embodiment, and the actual rate measured at the AP;

FIG. 8 shows, by means of three waves, the wireless capacity obtained by an estimation performed according to an embodiment of the method of the invention, indicated as THEMIS, an estimation performed according to [2] and the expected wireless capacity;

FIG. 9 illustrates the duty cycles evolution with one station obtained according to an embodiment of the method of the first aspect of the invention, where a station A is associated to three APs;

FIG. 10 shows the deployment (a) and results (b), in terms of throughput aggregation, of an embodiment of the method of the first aspect of the invention where two stations are connected to three access points;

FIG. 11 shows two stations sharing partially overlapping sets of APs where station B cannot obtain the throughput obtained by station A, according to an embodiment of the method of the first aspect of the invention, where (a) shows the arrangement deployment and (b) the obtained results in terms of throughput aggregation;

FIG. 12 discloses the fair share results of the backhaul bandwidth using THEMIS for the same deployment shown at FIG. 1(a);

FIG. 13 shows a Testbed deployment, where APs and stations have been deployed over three floors, ground floor (on the left), mezzanine (in the middle), and first floor (on the right). Each circle represents an AP, while stations are placed nearby the APs, one station per AP. Only stations A, B and C, relevant for some experiments, are shown in the map. Obstacles, as walls and desks are presented between all the AP links;

FIG. 14 shows the results of the wireless link quality assessment performed at the Testbed deployment of FIG. 13;

FIG. 15 shows the assessment of the topology unfairness in the residential-like deployment of FIG. 13, running the test using a throughput maximization algorithm as in FatVAp [2] (a) and THEMIS (b); and

FIG. 16 shows a Test, with reference to the deployment of FIG. 13, with the effect of the three types of unfairness: station A uses P2P traffic, station B is unluckily located (starts after 1200 s) and station C is a low priority station (starts after 2400 s).

### DETAILED DESCRIPTION OF SEVERAL EMBODIMENTS

Aggregating multiple 802.11 Access Point (AP) backhauls using a single-radio WLAN card has been considered as a way of bypassing the backhaul capacity limit. However, current AP aggregation solutions greedily maximize the individual station throughput without taking fairness into account. This can lead to grossly unfair throughput distributions, which can discourage user participation and severely limit commercial deployability. Motivated by this problem, THEMIS is here presented, a single radio station (as per the second aspect of the invention) that performs multi-AP backhaul aggregation in a fair and distributed way, without requiring any change in the network. THEMIS is implemented on commodity hardware, evaluated extensively through controlled experimental tests, and validated in a deployment spanning 3 floors of a multistory building.

In order to address the unfairness situations described above, next the fairness requirements as understood regarding the present invention will be introduced. First it has to be ensured that fairness is achieved at the level of the station's total received throughput, as opposed to individual flows or packet level fairness (per-station fairness). Second, to ensure that users with better subscription plans (e.g. faster broadband links) obtain greater share of the aggregated AP backhaul bandwidth than users with cheaper subscription plans. Thus, in the examples above the throughput should be obtained proportionally to their priority (weighted fairness). Third, fairness should be enforced across all shared APs, and not just at the single AP level to ensure a fair global throughput allocation (across-AP fairness).Fourth, to provide a fairness scheme that is efficient in terms of network utilization and strikes a good balance between fairness and throughput (efficient fairness). And finally, to provide a fairness scheme that is stable and has good convergence properties (stable fairness). Furthermore, in order to facilitate a wide adoption, the impact on the existing network infrastructure is minimized.

There are different reasons why the above requirements cannot be achieved using existing network technologies. For instance, in infrastructure mode, 802.11 does not provide per-station fairness because its downlink behaviour is largely dominated by its FIFO packet level scheduler [6]. TCP, on the other hand, only provides per-flow fairness among competing downlink flows, which is in fact the cause of the flow distribution unfairness [7]. Even if one would manage to implement some fairness mechanism at the individual AP level (for example changing the FIFO behaviour or introducing some clever time-based scheduler [8]), this would not result in across-AP fairness without the use of explicit signalling among the APs.

### Choice of Fairness for the Invention

In wireless systems, it is well known that fairness and throughput are often at odds [9]. For instance, imagine a scenario where two stations are sharing a wireless medium, and their wireless speeds are at a ratio of 10:1. A throughput optimal allocation would only allow the fast station to transmit, because every time slot devoted to the slow station would be wasted in low speed, losing the chance of a fast transmission. At the other extreme, a max-min fair allocation (e.g. one that maximizes the minimum of all station throughputs) would equalize the throughput transmitted by both stations. This allows the slow station to transmit most of the time, causing performance anomaly [9], that severely reduces the overall throughput.

Proportional fairness lies in the middle of the two extremes, providing a good compromise between fairness and efficiency (e.g. in [10]). It also achieves a good trade-off in terms of convergence and stability as shown in [11]. Finally, it allows for weighted fairness formulation. Weighted proportional fairness meets our efficient, stable and weighted requirements.

To comply with the other two requirements (per station and across-AP fairness), it is not possible to rely on existing formulations such as those in [2]. In fact [2] uses a knapsack scheduler that maximizes the individual station's throughput, and does not consider how the aggregate throughput is partitioned across stations. As a result, it is needed a new formulation that takes this problem into consideration. Next, it is described.

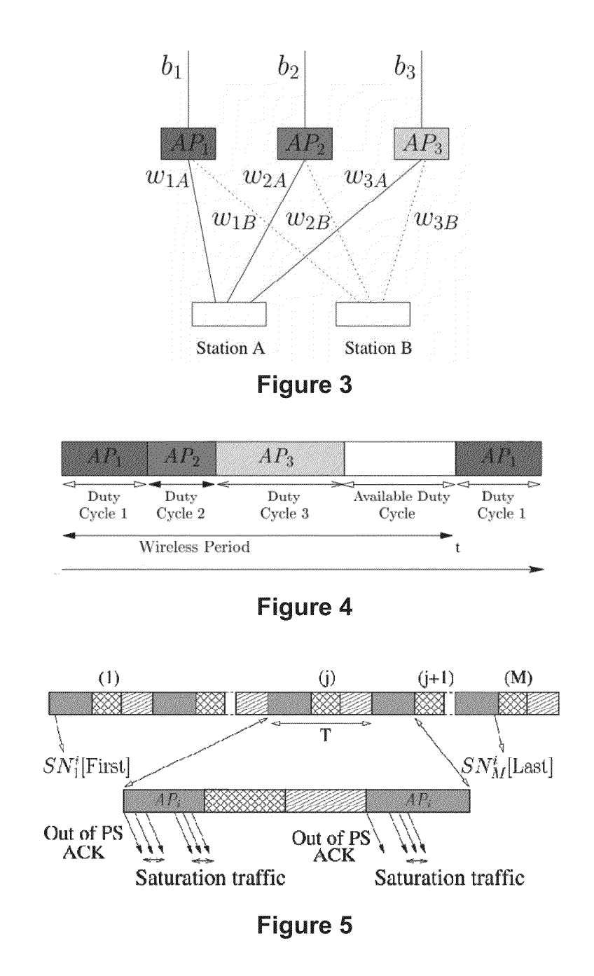

Recall the scenario depicted in FIG. 3. Let S be the set of stations and A the set of APs. Denote Tᵢₖ as the throughput sent from APᵢ to station k. And let yₖ=Σ_{i∈A}Tᵢₖ denote the total throughput received by station k. Let U(•) be a differentiable, strictly concave, increasing function which represents the utility at every station as a function of the received throughput. The fairness problem is modelled as:

$$\begin{matrix}max {\sum }_{k ∈ S} U ( {y}_{k} ) & ( 1 ) \\ s . t . {\sum }_{k ∈ S} {T}_{ik} \leq {b}_{i} , ∀ i ∈ A , & ( 2 ) \\ {\sum }_{i ∈ A , {w}_{ik} > 0} \frac{{T}_{ik}}{{w}_{ik}} \leq 1 , ∀ k ∈ S , & ( 3 ) \\ {T}_{ik} \geq 0 , ∀ i ∈ A , ∀ k ∈ S , & ( 4 )\end{matrix}$$

Where ωᵢₖ is the wireless capacity (It is to be noted that ωᵢₖ=0 if station k does not connect to APᵢ.) at which station k can receive from APᵢ, that takes into account the interference from other clients connected to that AP, and bᵢ is the backhaul capacity of AP_{i.}

For simplicity, and given that current residential traffic is heavily biased towards downloads, the formulation only considers downlink traffic. However an equivalent formulation can be designed for uplink traffic.

Equation (2) is the AP backhaul capacity constraint, and ensures that the total traffic traversing the APᵢ backhaul does not exceed the backhaul capacity bᵢ. Equation (3) corresponds to the station k wireless capacity constraint, and guarantees that the total traffic received by station k does not exceed the total capacity of its wireless interface. Finally (4) forces the values Tᵢₖ to be positive. It has to be noted that there exists an additional constraint not included in the formulation, corresponding to the AP wireless capacity constraint, namely

$${\sum }_{k ∈ S} \frac{{T}_{ik}}{{w}_{ik}} \leq 1 , ∀ i ∈ A .$$

This constraint ensures that the maximum capacity of the wireless interface at APᵢ is not exceeded. However, it has been analytically verified that this constraint may be violated only in the extreme cases of clients severely limited by the wireless. With THEMIS, this situation is avoided by preventing stations from connecting to APs if their signal-to-noise ratio (SNR) is very low. This makes sense, as a multi-AP aggregation scheme is only useful if the speed of WLAN is greater than the speed of the AP backhaul.

Finally, a weighted proportionally fair utility function U(yₖ)=Kₖ·log yₖ is chosen, where Kₖ represents the relative priority of user k (for example, a value linearly dependent to the AP backhaul bandwidth owned by user k). If all the users have the same priority then Kₖ=1 is used.

### Decomposition and Interpretation:

As described in [11], the solution of the above optimization problem can be obtained via the primal-dual formulation using a gradient descent algorithm. From there the following optimal rate update rule is derived

Tᵢₖ=\hat{T}ᵢₖα(U′(yₖ)−pᵢ−qᵢₖ), (5)

Where \hat{T}ᵢₖ, is the bandwidth request in the previous step of the algorithm, U′(yₖ) is the derivative of the utility function evaluated at the current throughput received by the station yₖ, and α is the step size of the rate update algorithm (when using proportional fairness, and in order to reduce oscillations as suggested by [12], it is used α=α′y k, with α′ the new step size). The quantities pᵢ and qᵢₖ are the prices corresponding to constraints (2) and (3) respectively, calculated as follows:

$$\begin{matrix}{p}_{i} = {[ {\hat{p}}_{i} - \frac{δ}{{b}_{i}} ( λ {b}_{i} - {\sum }_{k ∈ S} {T}_{ik} ) ]}^{+} , & ( 6 ) \\ {q}_{ik} = {[ {q}_{ik}^{′} - \frac{γ}{{w}_{ik}} ( μ - {\sum }_{i ∈ A} \frac{{T}_{ik}}{{w}_{ik}} ) ]}^{+} , & ( 7 )\end{matrix}$$

Where \hat{p}ᵢ, \hat{q}ᵢₖ, are the prices obtained in the previous step of the algorithm, and δ and γ are the step sizes of the price update algorithm. In order to improve the network utilization, and as suggested in [12], the price step size is normalized by the link capacities to favour good links. Finally λ, μ<=1 are the congestion thresholds and (x)⁺=max(x, 0).

The price pᵢ in (6) represents the level of congestion on the backhaul of APi, and it is a linear function of its available bandwidth. Similarly, qᵢₖ in (7) represents the level of congestion on the wireless link from station k to APᵢ, and it is a function of the available card time at the station (the time that the card is not being used for transmitting or receiving). As congestion increases, the respective prices will increase and the throughput demand Tᵢₖ of station k through APᵢ will decrease according to (5).

The values λ and μ are the congestion thresholds, i.e. respectively the level of utilization of the APᵢ backhaul and the wireless radio-interface of station k that will trigger the algorithm congestion control. When that happens, the prices pᵢ and qᵢₖ increase, prompting the throughput requests for their respective paths to decrease (the values of the congestion thresholds represent a performance threshold: the closer to 1 the better if for the network utilization, but the worse is for the short-term fairness of the algorithm).

In order to distributedly solve the optimization problem in (1), each station has to periodically obtain the prices (6) and (7) for its links, and then update its rates following (5). However, implementing this algorithm locally at each station without sharing information with the APs and/or other stations has the following challenges:
once the values Tᵢₖ in (5) are obtained at station k, those rates need to be enforced at APᵢ.
in order to calculate the prices pi in (6) and qᵢₖ in (7), each station k needs to obtain the values of bi and Tᵢⱼ, j≠k, which are not directly available at the station. Moreover each station k needs to accurately know the wireless capacity ωᵢₖ of each APᵢ.
a single-radio station has to manage the communication with multiple APs on independent radio frequencies. And it has to do it efficiently and using standard compliant 802.11.

Addressing the above challenges in a real system requires careful design and implementation, which is described in the next embodiment.

As indicated in a previous section, the single radio station of the second aspect of the invention has been implemented in a prototype named THEMIS. THEMIS is a single-radio wireless station based on the MadWiFi 0.9.4 driver [13] and the Click modular router 1.6.0 [14], that connects to multiple APs and aggregates their backhaul bandwidth. As shown in FIG. 4, THEMIS communicates separately to APs at different radio-frequencies using Time-Division Multiple Access (TDMA). Once connected to one AP, THEMIS transmits and receives traffic according to the 802.11 DCF protocol. The amount of time spent on APᵢ is denoted duty cycle fᵢ. The constant time T that THEMIS takes to perform a standard TDMA cycle is called wireless period. THEMIS will use any spare duty cycle to do other operations such as AP scanning or saving energy.

Next the components of THEMIS are described.

### Scheduler:

Let's consider a THEMIS station running the optimization algorithm in (1), and calculating the request rate to APᵢ to be Tᵢₖ in (5). In principle, in order to collect the bandwidth Tᵢₖ from APi, station k needs to connect to APᵢ during a duty cycle fᵢₖ=Tᵢₖ/ωᵢₖ, where wᵢₖ is the wireless capacity from APᵢ to station k. By reducing the time spent on APᵢ, the duty cycle fᵢₖ effectively acts as a gauge that limits the amount of bandwidth that can be received from the AP. As a consequence, TCP flows adjust their transmission rate to meet the request Tᵢₖ.

There are cases where station k does not receive the expected traffic Tᵢₖ during the duty cycle fᵢₖ. There are various reasons for this discrepancy: wireless losses, congestion in the AP queue, CSMA contention delays in the wireless links, etc. A correction factor Hᵢₖ=Tᵢₖ/xᵢₖ is introduced to account for the deviation between the expected received traffic Tᵢₖ and the actual traffic xᵢₖ received by station k from APᵢ during the selected duty cycle fᵢₖ.

As a result, THEMIS connects to APi for

$${f}_{ik} = {σ}_{ik} \frac{{T}_{ik}}{{w}_{ik}} + {c}_{i} , \qquad ( 8 )$$

Where σᵢₖ is the correction factor, and cᵢ is the overhead of switching from one AP to the next. Note that after applying the correction factor it may happen that the corrected duty cycles exceed the allowed time, violating the station k wireless capacity constraint, i.e.

$${\sum }_{i ∈ A} {f}_{ik} > 1.$$

In that case the wireless period is proportionally distributed as follows:
In a first step the duty cycles for those stations that overestimated it are reduced, i.e., the adjusted duty cycles f′ᵢₖ are recalculated as follows:

$${f}_{ik}^{′} = \{ \begin{matrix}{σ}_{ik} {f}_{ik} & if {σ}_{ik} \leq 1 \\ {f}_{ik} & otherwise\end{matrix}$$

Once adjusted, if the demanded duty cycles exceeds the capacity of the card, i.e. Σᵢf′ᵢₖ>1, then they are normalized f″ᵢₖ=f′ᵢₖ/Σᵢf′ᵢₖ. If, on the other hand, there is spare time fₛₚ= 1̅−Σᵢf′ᵢₖ, it is distributed among the links that need to increase their duty cycles (σᵢₖ>1) proportionally to their needs as follows:

$${f}_{ik}^{″} = \{ \begin{matrix}{f}_{ik}^{′} + {f}_{sp} \frac{{σ}_{ik}}{{\sum }_{i} {σ}_{ik}} & if {σ}_{ik} > 1 \\ {f}_{ik}^{′} & otherwise\end{matrix}$$

Each station uses the resulting values f″ᵢₖ.

### Estimators:

The calculation of the duty cycle fᵢₖ in (8) at station k for a given APᵢ and the update of the prices pᵢ and qᵢₖ in (6) and (7) require the following information:
the utilization rate

$${b}_{i} = {\sum }_{k ∈ S} {T}_{ik}$$

of the AP, backhaul.
the wireless capacity ωᵢₖ, that determines the maximum transmission rate of the wireless link.
the AP backhaul capacity bᵢ, that measures the maximum speed at which the APᵢ backhaul can send traffic.

A straightforward way to obtain those values would be to introduce new signalling to exchange this information between the APs and the stations. However, that would introduce extra overhead, and would also require modifying (or replacing) the existing AP installed base. To avoid it, THEMIS estimates these values locally. It has to be noted that is important to achieve high accuracy on the estimations, because wrong estimations would affect the performance of the scheduler. This is a hard problem because:
AP backhaul: the AP backhaul is shared with other stations and any measure of the APi utilization rate βᵢ and capacity bᵢ must be done in the limited slice of time fᵢₖ·T that station k dedicates to APᵢ.
wireless link: the wireless capacity of one AP has to be measured while the AP transmits in saturation. This is not guaranteed because the wireless link is usually not the bottleneck of the end-to-end communication.

Next how THEMIS estimates these values is described.

### Utilization Rate of the AP Backhaul

The estimation of the utilization rate βᵢ of the AP backhaul relies on the fact that every frame sent by an 802.11 AP carries a MAC Sequence Number (SN) in the header. The SN is a module 4095 integer incremented by the AP each time a new frame is sent, and it is independent of the destination. THEMIS stations listen to the traffic sent by APᵢ, and store its SNs. By counting the SNs, the THEMIS station knows the amount of packets traversing the APᵢ backhaul (Here it is assumed that most of the 802.11 data traffic traversed the AP backhaul, as it is often the case when using 802.11 in infrastructure mode). It has to be noted that this way of counting is robust to packet loss and disconnection periods, as long as the stations do not miss more than 4095 successful frames (retransmitted frames do not increase the SN), which for an average 802.11 frame size would correspond to seconds, an order of magnitude larger than the THEMIS' TDMA period (to increase the accuracy of the estimation, THEMIS operates in promiscuous mode, thus accounting for the information of the packets sent to other THEMIS).

Formally, related with FIG. 5, it is denoted SN₁ⁱ [First] and SN_{M}ⁱ [Last] the MAC sequence number of the first and last packet, respectively, sent by APᵢ to any station, during a window of time M·T, where M is an integer equal or greater than 1. Then, THEMIS derives the number of packets sent from APᵢ in the time M·T as:

Nⁱ=(SN_{M}ⁱ[Last]−SN₁ⁱ[First])mod 4095

Let's also denote E[Lᵢ] the average bit length per packet at IP layer over all the packets received by station k when it is connected to APᵢ. It is made the reasonable hypothesis that E[Lᵢ] does not change between the connection and disconnection time from APᵢ. Finally, the APᵢ backhaul utilization rate is calculated as:

$${β}_{i} = \frac{E [ {L}_{i} ] \cdot {N}^{i}}{M \cdot T} . \qquad ( 9 )$$

### Wireless Capacity

THEMIS measures the wireless capacity by calculating the packet dispersion of frames directed to it when the AP is transmitting in saturation. In order to detect saturation periods, station k run-time senses the wireless channel occupancy, that is, the percentage of time that the channel is busy, between two consecutive received packets. These statistics are collected from specific 802.11 baseband registers, exposed by the NIC card. If the occupancy is above a certain threshold (80% in the implementation of the authors), it is defined the AP in saturation for that pair and store the packet length of the second packet and the dispersion between the packets. Then, referring to FIG. 5, ωᵢₖ is derived averaging over the window of measure M·T as:

$${w}_{ik} = \frac{{\sum }_{j = 1}^{M} {B}_{j}}{{\sum }_{j = 1}^{M} {T}_{j , SAT}^{i}} , \qquad ( 10 )$$

Where Bⱼ is the sum of the packet length in saturation sent from APᵢ to station k and Tⱼⁱ,_{SAT} is the sum of the dispersions when station k receives in saturation mode during the j-th connection to APᵢ. It has to be noted that ωᵢₖ takes into account the existing interference, and depends on the current PHY rate of APs and stations, the signal quality, and the performance anomaly [9] during the measurement period.

### AP Backhaul Capacity:

Several Internet services can be used to estimate the AP backhaul capacity bᵢ, some of them also provided by ISPs to their clients. Usually, a file coupled to a script is downloaded from a server. The script detects when the client has completed the download and determines bᵢ.

The server report may be hindered by the cross-traffic rate of the packets (eventually) being sent through the same APᵢ backhaul to the other stations. THEMIS connects to a capacity server, but instead of relying on the server report, it calculates the peak reached by the utilization rate βᵢ during the connection time to the capacity server as:

$${b}_{i} = {max \overline{{β}_{i} [ l ]}}_{l = 1 , 2 , … L} ,$$

Where L represents the number of measures during the test at the 1/(MHT) rate, and βi[l] denotes the smoothed average of βᵢ[l] after the l-th calculation.

### Multiple APs Manager

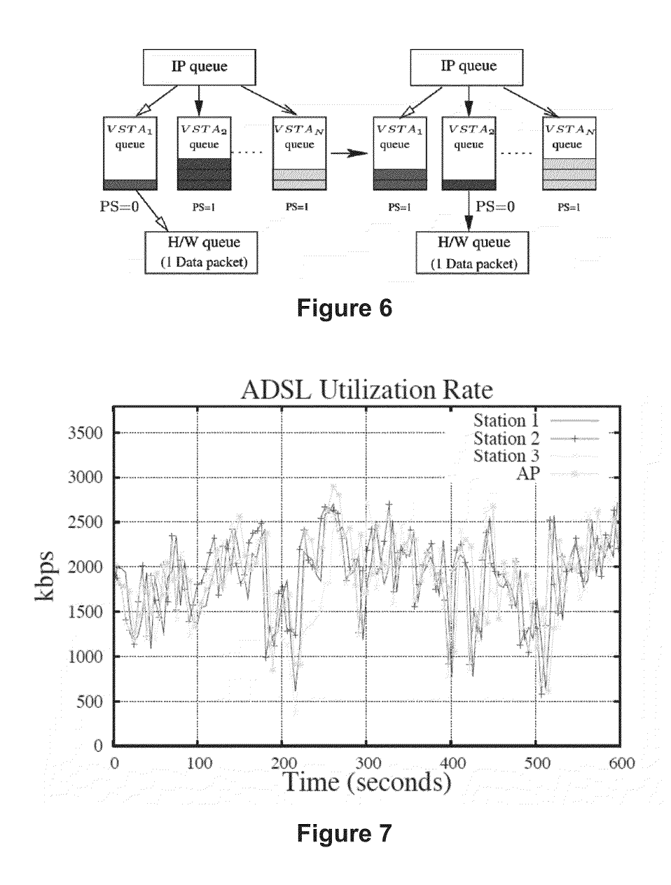

In order to provide an efficient TDMA implementation in THEMIS, the wireless driver on top of the single radio interface is virtualized, i.e., it appears as independent Virtual Stations (VSTAᵢ) associated to their respective APs. Each VSTAᵢ is responsible for managing the data communication with APᵢ and the related procedures such as association, authentication and scanning. To prevent losses during the TDMA operation, each THEMIS station k uses the 802.11 Power Save (PS) feature as follows as shown in FIG. 6:
During the active duty cycle, VSTA1 exchanges traffic according to the 802.11 protocol, while the other VSTAₛ are dormant in PS mode. During the PS time, both the AP1 and the station can only buffer packets [2, 5, 15].
When the duty cycle expires, VSTA₁ sends a frame to inform AP₁ that it is going into PS mode. Once received the MAC ACK, VSTA₁ and AP₁ start to buffer the packets destined to each other.
THEMIS assigns the control of the card to VSTA₂ and switches to the AP₂ radiofrequency.
VSTA₂ sends a frame to AP₂ to indicate that it is ready to send/receive traffic, and awaits for the MAC ACK.

The process continues until the station has cycled through all the VSTAs. The spare duty cycle can be used for other operations such as scanning or sleeping (see FIG. 4). The station then restarts the TDMA cycle.

In order to minimize the switching cost ci in (8), THEMIS achieves a fine-grained timing at MAC/PHY level, using the following techniques:
THEMIS introduces a MAC virtual queue per AP. This allows to buffer packets in the MAC virtual queue, when THEMIS is selecting some other AP.
THEMIS efficiently manages a hardware buffer (common to all the VSTAs) of one (1) data packet to quickly switch among MAC virtual queues. This is a challenging task, because short H/W queues cause inefficiencies that negatively affect throughput (Packets in the hardware queue must be sent before the end of the duty cycle assigned to the VSTA. This causes a delay respect to the expected end of the duty cycle imposed by the THEMIS scheduler. The efficient management of a hardware buffer of size one minimizes any extra-delay).
In order to switch the PS state, THEMIS piggybacks the MAC PS bit on the header of the pending data on top of the MAC virtual queue. THEMIS reverts to the classical use of probes (as done in [2, 5]) in the rare event of not having data packets ready for transmission.

With the techniques described above, THEMIS incurs in a switching cost ci of about 1.2-1.5 ms, most of which (around 800 μsec) is spent in hardware radio-channel commutation. This limited overhead, significantly less than [2, 5], increases the stability of the system by reducing the jitter in the switching procedure. This enables a fine-grained selection of duty cycles assigned by the scheduler even if the station transmits in saturation mode, which is of particular importance for TCP traffic.

On top of the MAC implementation, THEMIS uses a flow mapper to assign new TCP flows from the upper layers to a specific VSTA. It could be used a more sophisticated flow mapper, but finally was employed a proportional based mapper as in [2]: the amount of traffic rᵢₖ assigned to APi maintains the proportions of the bandwidth obtainable from each AP and equal to

$${r}_{ik} = \frac{{f}_{ik} {w}_{ik}}{{\sum }_{j} {f}_{jk} {w}_{jk}}$$

Finally, THEMIS implements a Reverse-NAT module that i) makes sure that the packets leave the station with the correct source IP address (i.e. the one corresponding to the outgoing VSTA, as assigned by the AP), and ii) presents a consistent (dummy) IP address to the applications, providing IP transparency to higher layers.

### Evaluation of THEMIS Estimators:

First the accuracy of the estimators used by THEMIS is verified. It starts studying the estimation of the backhaul utilization rate βᵢ in a test where three THEMIS stations download HTTP files using 3 Mbps lines. Stations are connected to the AP using a fixed connection time of 25 ms over a period of 100 ms. Stations are not synchronized, and they connect to the corresponding APs at independent times. Consequently, stations can only observe a fraction of the traffic load sent to other stations. Moreover, because of the wireless nature, they may not receive some packets sent to other stations, missing information such as the sequence number SN and packet length Lᵢ needed by the estimator in (9).

In this configuration, they are compared the estimations of the backhaul utilization rate over the time at each THEMIS station with the actual rate measured at the AP. The results disclose that all stations obtain a very accurate estimation as shown in FIG. 7.

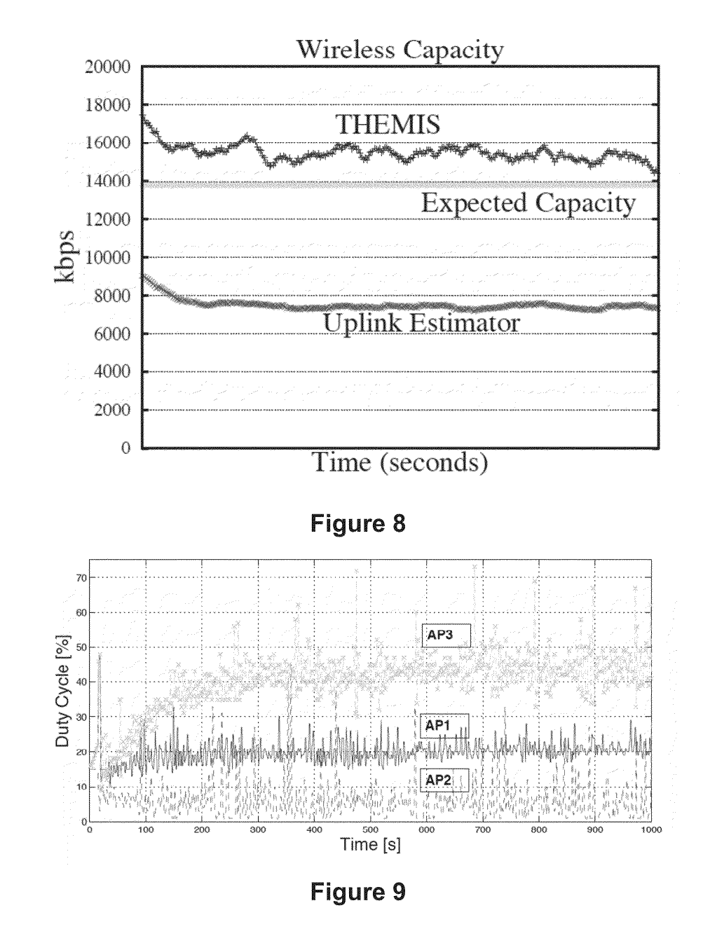

Next the THEMIS' wireless capacity estimator is evaluated. In the test, the THEMIS station connects to an AP with a duty cycle of 25 ms over a period of 100 ms, and performs several HTTP downloads from different Internet servers. In FIG. 8 is shown the estimation of wᵢₖ in a period of 4 minutes. THEMIS estimator gives a good approximation (around 13.7 Mbps) of the speed reported with a downlink Iperf test from a server located in the same LAN of the AP.

Estimators of ωᵢₖ are also proposed in [2, 16]. However, these estimators are based on the time needed to transmit a packet from the 802.11 station, and so they better represent uplink speeds rather than downlink. This can result in severe errors in the estimation of the downlink wireless capacity. As an example, FIG. 8 shows the performance of the estimator in [2] for the same scenario, and it can be seen that it under-estimates the wireless capacity. In fact, a high downlink speed will cause a long air-time before transmitting a packet in uplink, that translates in a low (and erroneous) downlink wireless capacity estimation.

### System Evaluation:

The system implementation of THEMIS has been evaluated through different tests. For every scenario, they five tests of 1800 secs have been run and plot the average results obtained. Such a configuration is chosen to verify that results are stable in time and across different tests. To achieve independent tests, stations are configured so that the THEMIS estimators are reset after each test. For the transport layer, it is used Linux standard TCP Reno with SACK and delayed ACK option enabled and it is emulated the AP backhaul capacities using the tc Linux traffic shaper. Unless otherwise stated: i) it is opened a TCP flow per AP using iperf, ii) the AP backhaul capacity is known at each station k, while the ADSLs utilization rates {βᵢₖ}, and the wireless capacities {ωᵢₖ} are estimated at THEMIS station k through the wireless capacity estimator.

THEMIS Parameters:

Selecting the appropriate wireless period represents a complex trade-off. On one side, switching among APs introduces overhead, so selecting long wireless periods is more efficient. However, long periods affect TCP performance because they artificially increase the end-to-end delay. On the other hand, short periods reduce the disconnection time from the APs in PS mode, and prevent TCP from timing-out, but are more inefficient. As a good balance, a wireless period T of 100 ms is selected. The scheduler and estimators are updated every 20·T=2 seconds. It is also imposed that the time of connection to each AP is at least equal to the switching cost plus 2 ms (that gives a minimum duty cycle fᵢ≧0.03).

The values of α(5), β(6) and γ(7) have been selected based on extensive simulations, with values that provide a good trade-off between convergence and stability. Similarly, for the congestion thresholds for the AP backhaul and the wireless capacity are chosen λ=0.95 and μ=0.95 respectively. A more detailed sensitivity analysis of the parameters falls outside the scope of the present invention.

Two Stations Connected to One AP:

The configuration where two stations are connected to the same AP (802.11 legacy operation) is first considered. In the test, it is considered that both stations receive traffic from the AP at a downlink wireless rate of about w₁=20-22 Mbps and are connected to an AP backhaul of b₁=7 Mbps (This is the AP backhaul capacity, and hence the actual speed available for TCP traffic may be lower. In fact, because of TCP's sawtooth behaviour, not all the available bandwidth at the bottleneck may be used at any time. The bandwidth utilization per path can increase establishing more than one TCP connection over each AP). It is also considered that station A opens one TCP flow per AP while station B opens 10 TCP flows per AP.

The results are summarized in next Table:

| | station A | station B |
|---|---|---|
| 802.11 Legacy | 0.45 Mbps | 6.24 Mbps |
| THEMIS | 3.15 Mbps (f = 0.19) | 3.40 Mbps (f = 0.15) |

With legacy 802.11, station B uses most of the backhaul capacity with an average received throughput of 6.24 Mbps while station A starves at 0.45 Mbps, at a throughput more than 13 times smaller than station A. On the other hand, each THEMIS station connects for a limited percentage of card time on each AP to collect the requested bandwidth T₁ₖ. The result is that station B—that opens more flows—connects less time than station A, i.e. 14% versus 19% of their time, and then for just a few ms of the entire wireless period. Indeed station B needs in average less time to achieve the bandwidth from the AP, because it is less affected by the TCP's sawtooth behaviour of each flow. As a result, stations A and B obtain similar throughput (3.15 Mbps vs. 3.40 Mbps), with a network utilization of 6.55 Mbps instead of 6.69 Mbps, a consequence of the THEMIS congestion control. In next table can be observed the results for two stations connected to one AP.

One Station Connected to Multiple APs:

In these tests the efficiency is evaluated in terms of network utilization with one THEMIS station connected to multiple APs. Let's first consider the case where the throughput is not limited by the wireless card speed on any of the connections, i.e. the expected result is to completely utilize the available backhaul capacity of the APs.

Consider station A is associated to three APs, at a downlink wireless rate of about w₁=w₂=w₃=20 Mbps and is connected to AP backhauls of b₁=5 Mbps, b₂=1 Mbps and b₃=10 Mbps respectively, with a total bandwidth of 16 Mbps. As it is shown in FIG. 9, the duty cycles converge to stable range of values. THEMIS spends most of the time on the best network path (via AP₃) and less time on the worst network path (via AP₂). This results in a total aggregated throughput of 15.05 Mbps, that is with an average utilization of 94% of the network aggregated capacity, as it is expected from the setting of λ=0.95.

Then it is considered a scenario where a THEMIS station connects to two APs, and is limited by the wireless speed on one link. In the test, a THEMIS station measures a downlink wireless capacity of w₁=20.74 Mbps on APᵢ and w₂=2.73 Mbps on AP₂ and is connected to AP backhauls of 5 Mbps each, bottlenecked by the wireless on path 2.

Results are summarized in the next table:

| | AP₁ | AP₂ | |
|---|---|---|---|
| Capacity | b₁ = 5 Mbps | b₂ = 5 Mbps | b₂ = 2.73 Mbps |
| Duty Cycle | 0.25 | 0.71 | 0.67 |
| Throughput | 4.74 Mbps | 2.43 Mbps | 2.21 Mbps |

Two settings have been considered: first, the ideal case where the AP backhaul capacities are correctly estimated at 5 Mbps, and second, the most realistic scenario where the estimation of the AP backhaul capacity of the path limited by wireless (path 2) is bottlenecked by the wireless capacity b₂=w₂=2.73 Mbps.

In the first case, THEMIS spends f₁=0.25 on the path with higher wireless speed, obtaining a throughput of 4.74 Mbps. The rest of the time it is spent in the path limited by the wireless link (f₂=0.71), where it achieves a throughput of 2.43 Mbps (for an aggregated 7.17 Mbps). It has to be noted that a small time (f=1−0.25−0.71=0.04) is used by THEMIS to detect card time congestions as shown in (7).

In the second case, the throughput achieved on path 2 slightly reduces to 2.21 Mbps, with a sub-utilization of the path of 2.43−2.21=0.21 Mbps. In fact, a smaller (and wrong) AP backhaul capacity estimation causes a higher AP backhaul price p₂ on the link, that in turn causes the station to request less throughput on this connection according to (5). This translates in a smaller duty cycle f₂=0.67 rather than 0.74, that in turns reduces the bandwidth received on this path.

In both tests, THEMIS makes an efficient usage of the network: the overall throughput is higher than the one obtained being connected 100% of the time to AP₁ (at most 5 Mbps) or to AP₂ (at most w₂=2.73 Mbps).

Multiple Stations Connected to Multiple APs:

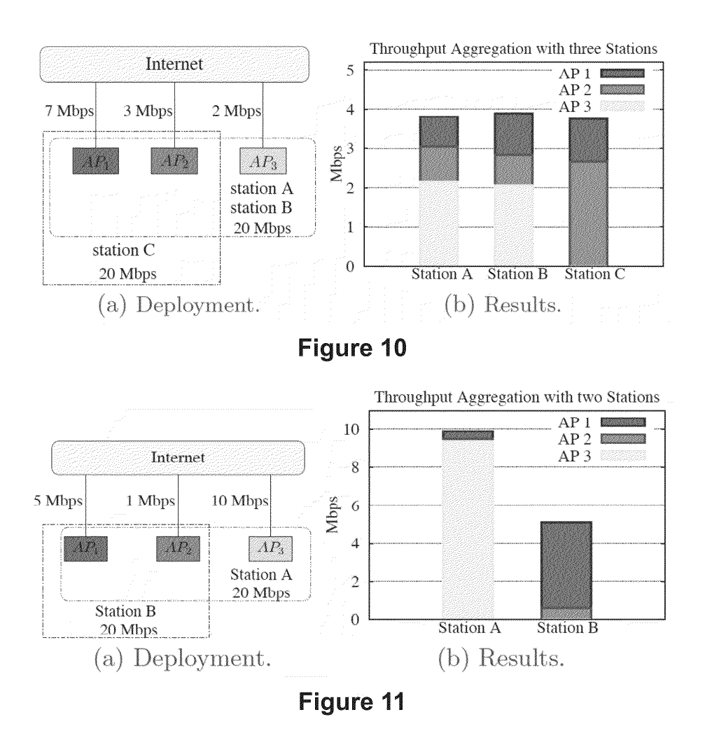

The fairness and the network utilization efficiency are evaluated, when different stations are connected to multiple APs. First, it is analysed the case of three THEMIS stations, in the scenario in FIG. 10(a), with three APs with backhaul speeds of b₁=7 Mbps, b₂=3 Mbps and b₃=2 Mbps respectively, resulting in a total aggregated capacity of 12 Mbps. Given that none of the stations is limited by the wireless links, each station is expected to get an average aggregated speed close to 12/3=4 Mbps, even if the stations share a different number of APs.

This is demonstrated in FIG. 10(b): the three stations obtain a fair share of the aggregate AP backhaul speed, averaging 3.80 Mbps, 3.89 Mbps and 3.75 Mbps on stations A, B and C, respectively, for a total aggregate throughput of 11.44 Mbps, again around the 95% of the overall available capacity.

Then the scenario in FIG. 11(a) is considered, where station B shares two AP backhauls with station A at wired speeds of 5 and 1 Mbps, respectively. Station A can also connect to a third AP (AP₃) with a backhaul speed of 10 Mbps. Then, station B can obtain at most 6 Mbps and can never reach the 10 Mbps speed of AP₃ backhaul.

The results in FIG. 11(b) show a total aggregate TCP throughput of 9.88 Mbps on station A (with fᵢ=0.08, f₂=0.05 and f₃=0.47), and 5.09 Mbps on station B (f₁=0.28, f₂=0.09). Station A makes the fair decision, reducing the amount of time connected to the shared APs as much as possible.

Stations with an Uneven Number of TCP Flows:

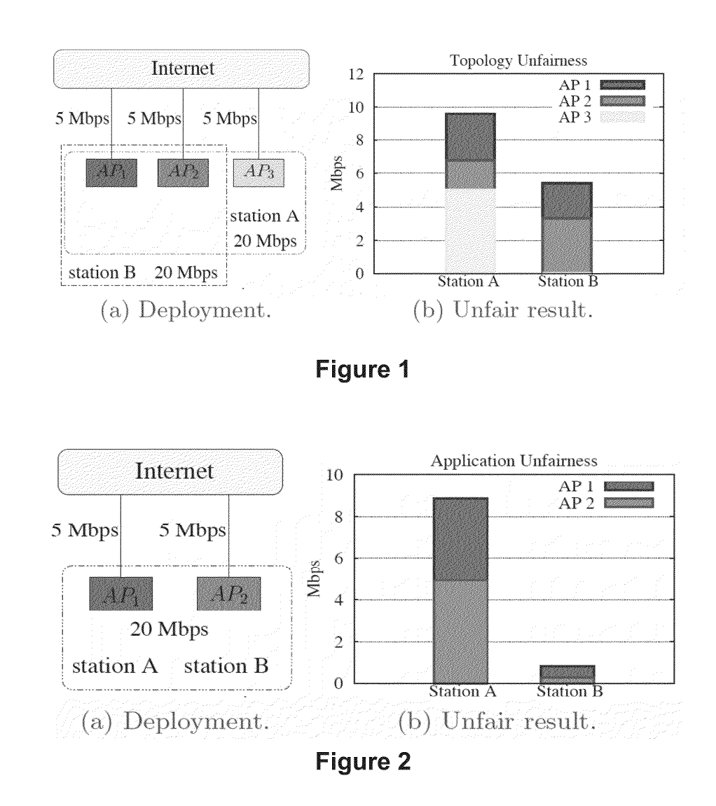

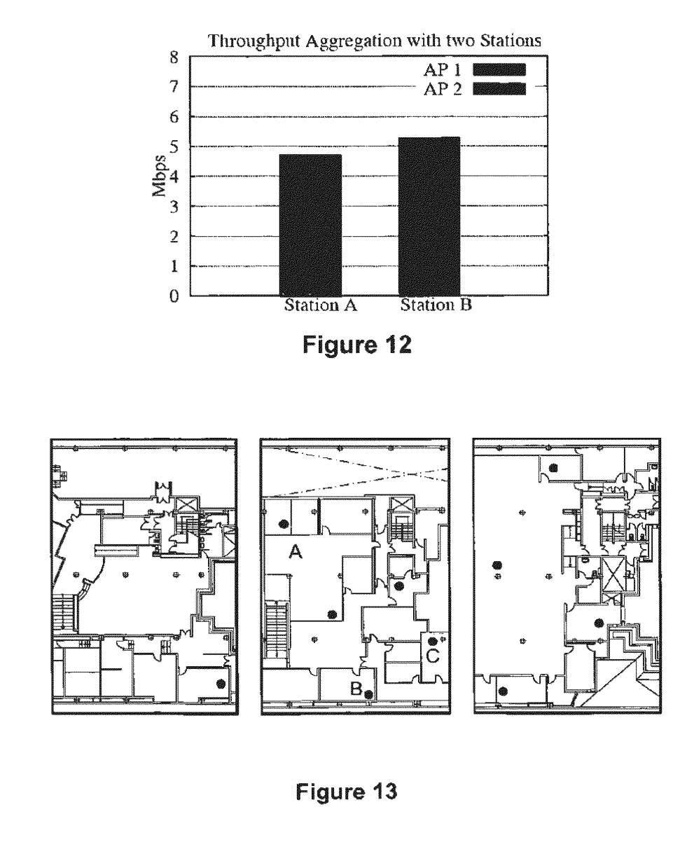

Here the flow distribution unfairness example shown in FIG. 1(a) is recalled, where two stations are sharing two 5 Mbps backhaul APs and use an uneven number of TCP flows. FIG. 12 shows that THEMIS is able to guarantee a fair share of the aggregated backhaul capacity to each station.

Stations with Different Priorities:

Consider the same scenario as before, where now station A and station B happen to be roaming and sharing two 5 Mbps AP backhauls. Let's consider that station A belongs to a user that has higher priority than the user of station B. For sake of illustration, it is supposed that THEMIS applies weighted proportional fairness using K_{A}=4 and K_{B}=1. Therefore, it is expected that station A obtains K_{A}/(K_{A}+K_{B})=0.8 of the total bandwidth while station B obtains the remaining K_{B}/(K_{A}+K_{B})=0.2. The experiments show that THEMIS stations obtain a throughput of 7.64 Mbps for station A and 2.0 Mbps for station B.

### THEMIS in a Realistic Scenario:

In order to test the scalability of THEMIS, a realistic testbed is deployed spanning three floors of a multistory building. The network consists of 10 commercial ADSLs with their corresponding WLAN APs and 10 THEMIS stations, i.e. the owners of each line. Nine of the ADSL lines have a nominal capacity of 3 Mbps and one has a nominal capacity of 1 Mbps. The APs are distributed every 80 square meters to emulate the average residential flat size (see FIG. 13) and are set to independent radio-frequencies in the 2.4 GHz ISM band (The channels optimization is out-of-the-scope of the present invention).

In the bootstrap phase, the APs are selected based on a passive analysis of the SNRs of the 802.11 AP beacons. Stations scan for the APs in range and start authenticating and associating to the APs, starting with the ones with highest SNR down to the ones with smaller SNR. THEMIS requires a minimum SNR of 10 dB to guarantee a stable reception at 1 Mbps PHY basic rate. In each test, automatic rate selection is active in each THEMIS station, with independent instances of the Minstrel rate selection algorithm [17] over each wireless uplink.

Characterization:

The capacity of each link of the network (i.e. the ADSLs and the 10H10 wireless links) is measured. The findings are that the 3 Mbps lines offer a constant maximum speed of 2.65 Mbps and the 1 Mbps line offers 0.89 Mbps. Regarding the wireless links, apart from the 10 “home” links where the station is located nearby the AP, the SNR measured per wireless link is consistently lower than 30 dB.

Then traffic from a server connected to the APs via an 802.3 LAN id generated, activating one AP-station link at a time, with 5 minutes dedicated to each test. The average throughput and the standard deviation for each link is calculated. Then, the 10 links are reordered in descending order per-station, based on the average throughput.

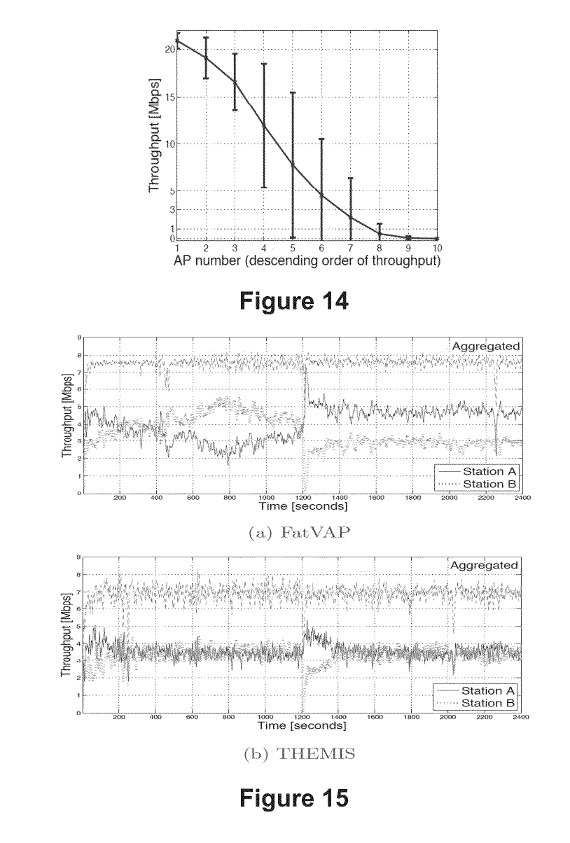

Results are reported in FIG. 14. Each station can receive TCP traffic from at least 3 Aps (and up to 5) at a speed higher than 10 Mbps. The results show the feasibility of aggregating the low-speed backhaul bandwidth of at least three APs.

### The Effect of Location:

To show the effect of location, a test is performed in which two stations (station A and station B as shown in FIG. 13) initially share the same set of APs and are located a few meters away from its “home” AP. For this test three APs connected to 3 Mbps lines are used, hence, the total backhaul capacity that station A and station B share is 2.65×3=7.95 Mbps. As a result, a fair share of the total bandwidth would be 7.95/2=3.975 Mbps per station. Both stations perform several HTTP downloads per AP during 2400 seconds. After 1200 seconds of test, station B moves to a second location from which it can only be connected to two of the former APs. As IP mobility is not implemented in our testbed, all the connections of station B are dropped and started again in the new location. As a consequence of the movement of station B, the topology of the network changes and stations observe an uneven AP backhaul capacity.

The test is run using a throughput maximization algorithm as in FatVAP [2] and using THEMIS, as shown in FIG. 15(a) and FIG. 15(b), respectively. Results show that, when the network topology is similar for both stations (they are both connected to three APs at similar speed), using throughput maximization results in a similar long-term performance for both stations, but with no guarantee of short-term fairness. Moreover, when the topology changes, station B is clearly penalized by its new unlucky location obtaining 2.8 Mbps while station A obtains 4.8 Mbps.

On the other hand, THEMIS guarantees a fair share of the backhaul capacity in both topologies, offering 3.5 Mbps to each station. It has to be noted that when station B moves to the new position, the PHY rate is quickly reduced because of the lower signal strength, with THEMIS quickly converging to a fair assignment of the backhaul capacity. Also note that because the fairness mechanism relies on the congestion thresholds λ and μ, the network utilization is slightly lower than the optimal.

### Integrated Operations

It has been shown via different deployments that THEMIS is able to deal with the three types of unfairness that arise when aggregating AP backhaul bandwidth. However, in a real life scenario, these unfairness can take place at the same time. Thus, it is performed a test that evaluates THEMIS in presence of a P2P station (station A), an unluckily located station (station B) and a low priority station (station C). The location of the stations is shown in FIG. 13. For this test three APs have been used, each with a 3 Mbps backhaul. The P2P and the low priority stations are connected to three APs while the unluckily located station is connected to two APs. Given that the low priority station owns a 1 Mbps ADSL while the others own a 3 Mbps ADSL line, the weights have been set to K_{A}=K_{B}=3 and K_{C}=1. In such experiment, a fair system should be able to allocate the bandwidth proportionally to the priority of the users.

At the beginning of the test, station A starts downloading P2P traffic from the three APs. After 1200 seconds, station B starts several HTTP downloads from the two APs it is connected to. Finally after 1200 seconds more, station C also starts HTTP traffic from the APs.

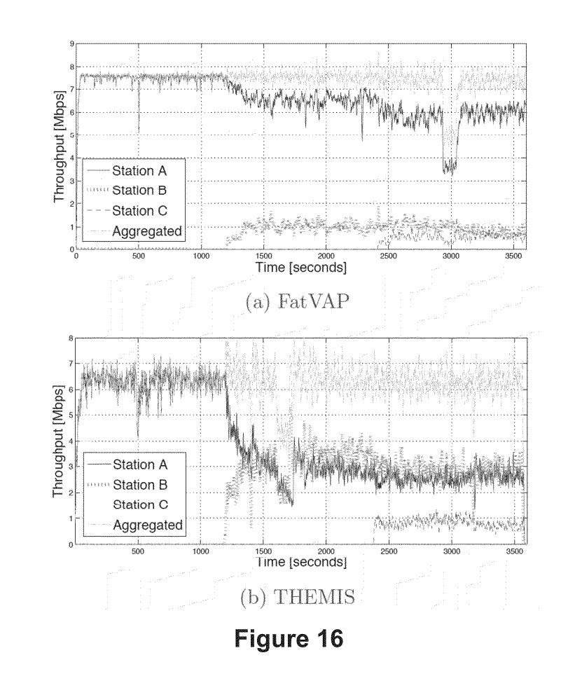

The result of using a throughput maximization algorithm is shown in FIG. 16(a). It is noticeable that station A, due to the high number of TCP flows opened by P2P applications, obtains most of the backhaul capacity preventing station B from obtaining its fair share of the bandwidth. Furthermore, when station C starts its downloads, the absence of priority among users further reduces the throughput obtained by station B, introducing billing unfairness. Finally, since station B and C achieve a similar throughput despite that station B is unluckily located, the flow distribution unfairness dominates over the topology unfairness.

The result of using THEMIS is shown in FIG. 16(b). When the unluckily located station B starts its downloads after 1200 seconds, the wireless capacity measured at station A over the shared APs is reduced because of the performance anomaly [9]. However, the system quickly adapts: the wireless links with lower wireless capacity receive a higher wireless price qᵢₖ and hence smaller throughput demand Tᵢₖ and dedicated duty cycle fᵢₖ. A smaller duty cycle for both stations A and B means that the probability of being connected to the same AP at the same time, and consequently the occurrence of performance anomaly, is reduced. Concluding, THEMIS offers a fair share of the aggregated bandwidth to both stations, while providing a high usage of the backhaul bandwidth. Finally, when station C starts its downloads, the priorities are preserved and stations A and B obtain a greater share of the backhaul capacity.

In the above described experiments, the APs are off-the-shelf Linksys, running Linux DD-WRTv24 firmware. The stations are Linux laptops, equipped with a single-radio Atheros-based wireless NIC. For every AP and station in the network, the wireless multimedia extensions (WME) and the RTS/CTS handshake are disabled. Any non-standard compliant 802.11 feature is also disabled, and H/W queues are set up with 802.11 best effort parameters.

It has been shown that fairness is a crucial factor for the success of multi-AP aggregation schemes. Without fairness, the perceived value of the system is severely reduced, eliminating the incentives of users to participate, and of providers to deploy it. This effectively renders the scheme unfeasible. In order to achieve fairness, existing multi-AP aggregation systems that maximize the throughput of single users cannot be extended. As a consequence a complete re-design of the system is required, which has been done by the present invention, particularly by THEMIS, a single-radio station implemented in commodity hardware that is fair in a multi-AP aggregation scenario. THEMIS operates locally at the station, using standard 802.11, without requiring any change in the network. This makes THEMIS ready to be deployed. In fact, THEMIS is being used by a major broadband provider in a commercial trial.

For several embodiments not described herein, THEMIS is extended to include uplink traffic in the formulation, the impact and trade-offs that TDMA may have over the TCP performance are overcome by an adequate correction/compensation mechanism, THEMIS is used to design more power efficient access networks, and THEMIS is leveraged to perform efficient large-scale cellular data offloading, which appears to be a difficult challenge for the years to come.

### Advantages of the Invention:

THEMIS has been evaluated in an extensive set of tests. The findings show that:
the estimators described above are accurate, and stations do not need to request information from the network.
THEMIS achieves a fair sharing of the aggregate network capacity among stations, while efficiently using the aggregated network capacity.

A person skilled in the art could introduce changes and modifications in the embodiments described without departing from the scope of the invention as it is defined in the attached claims.

### Acronyms

ADSL Asymmetric Digital Subscriber Line
UMTS Universal Mobile Telecommunication System

### REFERENCES

[1] D. Han, A. Agarwala, D. Andersen, M. Kaminsky, D. Papagiannaki, and S. Seshan, “Mark-and-Sweep: Getting the ‘Inside’ Scoop on Neighborhood Networks,” in Proc. Of the ACM IMC Conf., (Vouliagmeni, Greece), pp. 99-104, October 2008.
[2] S. Kandula, K. Lin, T. Badirkhanli, and D. Katabi, “FatVAP: Aggregating AP Backhaul Capacity to Maximize Throughput,” in Proc. of the USENIX NSDI Conf., (San Francisco, Calif.), pp. 89-04, April 2008.
[3] “FON.” http://www.fon.com/.
[4] X. Ai, V. Srinivasan, and C.-K. Tham, “Wi-Sh: A Simple, Robust Credit Based Wi-Fi Community Network,” in Proc. of the IEEE INFOCOM Conf., (Rio de Janeiro, Brazil), pp. 1638-1646, April 2009.
[5] R. Chandra and P. Bahl, “MultiNet: Connecting to Multiple IEEE 802.11 Networks Using a Single Wireless Card,” in Proc. of the IEEE INFOCOM Conf., (Hong Kong, China), pp. 882-893, March 2004.
[6] E. Park, D. Kim, H. Kim, and C. Choi, “A Cross-Layer Approach for Per-Station Fairness in TCP over WLANs,” IEEE Trans. Mobile Comput., vol. 7, no. 7, pp. 898-911, 2008.
[7] B. Briscoe, “Flow Rate Fairness: Dismantling a Religion,” ACM SIGCOMM Comp. Commun. Review, vol. 37, no. 2, pp. 63-74, 2007.
[8] G. Tan and J. Guttag, “Time-based Fairness Improves Performance in Multi-rate WLANs,” in Proc. of the USENIX Annual Tech. Conf., (Boston, Mass.), pp. 23-24, June 2004.
[9] F. R. G. B.-S. M. Heusse and A. Duda, “Performance Anomaly of 802.11b,” in Proc. Of the IEEE INFOCOM Conf., vol. 2, (San Francisco, Calif.), pp. 836-843, April 2003.
[10] H. J. Kushner and P. A. Whiting, “Convergence of Proportional-Fair Sharing Algorithms under General Conditions,” IEEE Trans. Wireless Commun., vol. 3, pp. 1250-1259, 2003.
[11] R. Srikant, The Mathematics of Internet Congestion Control (Systems and Control: Foundations and Applications). Springer Verlag, 2004.
[12] M. P. W. Wang and S. H. Low, “Optimal Flow Control and Routing in Multi-path Networks,” Elsevier Perform. Eval., vol. 52, no. 2-3, pp. 119-132, 2003.
[13] “Madwifi project.” http://madwifi-project.org.
[14] E. Kohler, R. Morris, B. Chen, J. Jannotti, and F. M. Kaashoek, “The Click Modular Router,” ACM Trans. Comput. Syst., vol. 18, pp. 263-297, August 2000.
[15] D. Giustiniano, E. Goma, A. Lopez Toledo, and P. Rodriguez, WiSwitcher: An Efficient Client for Managing Multiple APs,” in Proc. of ACM PRESTO Wrkshp., (Barcelona, Spain), pp. 43-48, August 2009.
[16] D. Malone, I. Dangerfield, and D. J. Leith, “Verification of Common 802.11 MAC Model Assumptions,” in Proc. of the ACM PAM Conf., (Louvain-la-Neuve, Belgium), pp. 63-72, April 2007.
[17] “Minstrel rate control algorithm.” http://linuxwireless.org/en/developers/Documentation/mac80211/RateContr%ol/minstrel.
[18] “Whisher Wifi Sharing Community.” http://www.whisher.com.
[19] E. Tan, L. Guo, S. Chen, and X. Zhang, “CUBS: Coordinated Upload Bandwidth Sharing in Residential Networks,” in Proc. of the IEEE ICNP Conf., (Plainsboro, N.J.), pp. 193-202, October 2009.
[20] N. Thompson, G. He, and H. Luo, “Flow Scheduling for End-host Multihoming,” in Proc. of the IEEE INFOCOM Conf., (Barcelona, Spain), pp. 1-12, April 2006.
[21] A. Nicholson, S. Wolchok, and B. Noble, “Juggler: Virtual Networks for Fun and Profit,” IEEE Trans. Mobile Comput., vol. 9, no. 1, pp. 31-43, 2010.
[22] S. Jakubczak, D. G. Andersen, M. Kaminsky, D. Papagiannaki, and S. Seshan, “Linkalike: Using Wireless to Share Network Resources in a Neighborhood,” IEEE Trans. Mobile Comput., vol. 12, no. 4, pp. 1-14, 2008.
[23] D. K. J. Strauss and F. Kaashoek, “A Measurement Study of Available Bandwidth Estimation Tools,” in Proc. of the ACM IMC Conf., (Miami Beach, Fla.), pp. 39-44, October 2003.
[24] V. Ribeiro, R. Riedi, R. Baraniuk, J. Navratil, and L. Cot, “pathChirp: Efficient Available Bandwidth Estimation for Network Paths,” in Proc. of the ACM PAM Wrkshp., (San Diego, Calif.), April 2003.
[25] D. Croce, T. En-Najjary, G. Urvoy-Keller, and E. W. Biersack, “Non-cooperative Available Bandwidth Estimation Towards ADSL Links,” in Proc. of the IEEE Global Internet Symp., (Phoenix, Ariz.), April 2008.
[26] D. Croce, T. En-Najjary, G. Urvoy-Keller, and E. W. Biersack, “Fast Available Bandwidth Sampling for ADSL Links: Rethinking the Estimation for Larger-Scale Measurements,” in Proc. of the ACM PAM Conf., (Seoul, South Korea), pp. 67-76, April 2009.
[27] J. P. R. Draves and B. Zill, “Routing in Multi-radio, Multi-hop Wireless Mesh Networks,” in Proc. of the ACM MobiCom Conf., (New York, N.Y.), pp. 114-128, October 2004.
[28] Toledo A. “ClubADSL: When your neighbours are your friends,” Computers and Communications, 2009. ISCC 2009. IEEE SYMPOSIUM ON, IEEE, PISCATAWAY, USA, 5 Jul. 2009.
[29] Srikanth K. Ching-Ju Lin K. “FatVAP: Aggregating AP Backhaul Capacity toMaximize Troughput,” USENIX ASSOCIATION, 18 Apr. 2008.
[30] Aguiar A. “Utility based packet scheduler for wireless communications,” LOCAL COMPUTER NETWORKS, PROCEEDINGS 2006 31^{ST} IEEE CONFERENCE ON, IEEE, PI, 1 Nov. 2006.

1. Method for managing station throughputs from a wireless multiple access points backhaul, comprising using a single radio interface per station and scheduling the throughput there for, where the method is characterised in that it is applied to connect stations to one or more access points (AP₁, AP₂, AP₃), through said single radio interface, and in that it comprises performing said scheduling by determining a throughput request Tᵢₖ for any station (k) to an access point (APᵢ), based on a previously received or requested throughput \hat{T}ᵢₖ , and calculating a corresponding duty cycle fᵢₖ during which said station (k) needs to connect to said access point (APᵢ) to receive said requested throughput Tᵢₖ.

2. Method, as per claim 1, comprising calculating said duty cycle fᵢₖ during which said station (k) connects to said access point (APᵢ) to receive said requested throughput Tᵢₖ by means of the next expression: fᵢₖ=Tᵢₖ/ωᵢₖ, where ωᵢₖ is the wireless capacity at which said station (k) can receive from said access point (APᵢ).

3. Method as per claim 1, comprising connecting said station (k), via said single radio interface, to said access point (APᵢ) during said duty cycle fᵢₖ.

4. A method as per claim 3, comprising performing said scheduling, including said duty cycle fᵢₖ calculus, for connecting said station (k) separately to a plurality of access points (AP₁, AP₂, AP₃) during the calculated duty cycle fᵢₖ, and performing said connections, via said single radio interface, at different radio-frequencies using Time-Division Multiple Access, TDMA.

5. A method as per claim 4, comprising, once the station (k) is connected to one access point (APᵢ) of said access points (AP₁, AP₂, AP₃), transmitting and receiving traffic according to the 802.11 DCF protocol.

6. A method as per claim 1, wherein said scheduling is also performed by running an optimization algorithm implementing the next expression:
$$max {\sum }_{k ∈ S} U ( {y}_{k} )$$
where yₖ=Σ_{i∈A}Tᵢₖ denotes the total throughput received by said station (k), and U(yk) is a function representing the utility or obtained throughput at the station (k) as a function of the received throughput.

7. A method as per claim 6, wherein said previously received or requested throughput T̅ᵢₖ is calculated by the following next expression or optimal rate update rule:
Tᵢₖ= T̅ᵢₖ+α(U′(yₖ)−pᵢ−qᵢₖ)
where:
U′(yk) is the derivative of U(yk),
α is the step size of said optimal rate update rule,
pᵢ is a price representing the level of congestion on the backhaul of the access point (APᵢ), and
qᵢₖ is a price representing the level of congestion on the wireless link from the station (k) to the access point (APᵢ).

8. A method as per claim 7, wherein said price pᵢ corresponds to an access point backhaul capacity constraint ensuring that the total traffic traversing the access point (APᵢ) backhaul does not exceed the backhaul capacity bᵢ of the access point (APᵢ), and which is defined by the next expression:
$$s . t . {\sum }_{k ∈ S} {T}_{ik} \leq {b}_{i} , ∀ i ∈ A ,$$
where S is the set of stations and A the set of access points.

9. A method as per claim 8, wherein price pᵢ is calculated/updated from the next expression:
$${p}_{i} = {[ {\hat{p}}_{i} - \frac{δ}{{b}_{i}} ( λ {b}_{i} - {\sum }_{k ∈ S} {T}_{ik} ) ]}^{+}$$
where \hat{p}ᵢ is the price obtained in a previous step of the optimization algorithm, δ is the step size of the price update, λ≦1 is a congestion threshold and (x)³⁰ =max(x,0).

10. A method as per claim 8, wherein said price qᵢₖ corresponds to the station (k) wireless capacity constraint guaranteeing that the total traffic received by the station (k) does not exceed the total capacity of its wireless interface, and which is defined by the next expression:
$${\sum }_{i ∈ A \cdot {w}_{ik} > 0} \frac{{T}_{ik}}{{w}_{ik}} \leq 1 , ∀ k ∈ S$$

11. A method as per claim 10, wherein price qᵢₖ is calculated/updated from the next expression:
$${q}_{ik} = {[ {q}_{ik}^{′} - \frac{γ}{{w}_{ik}} ( μ - {\sum }_{i ∈ A} \frac{{T}_{ik}}{{w}_{ik}} ) ]}^{+}$$
where \hat{q}ᵢₖ is the price obtained in a previous step of the optimization algorithm and γ is the step size of the price update, μ≦1 is a congestion threshold and (x)³⁰ =max(x,0).

12. A method as per claim 1, comprising correcting a deviation between the expected received traffic or requested throughput Tᵢₖ and the actual or real traffic xᵢₖ that the station (k) is receiving from said access point (APᵢ) during the selected duty cycle fᵢₖ by applying a correction factor σᵢₖ=Tᵢₖ/x_{ik,} and connecting said station (k) to said access point (APᵢ) during a corrected duty cycle:
$${f}_{ik} = {σ}_{ik} \frac{{T}_{ik}}{{w}_{ik}} + {c}_{i}$$
where cᵢ is the overhead of switching from one access point to a next one.

13. A method as per claim 12 comprising, for the calculation of the uncorrected or corrected duty cycle fᵢₖ and the calculation/update of the prices pᵢ and qᵢₖ, estimating the next parameters:
an utilization rate βᵢ=Σ_{k∈S}Tᵢₖ of the access point (APᵢ) backhaul;
said wireless capacity ωᵢₖ that determines the maximum transmission rate of the wireless link; and
said backhaul capacity bᵢ, that measures the maximum speed at which the access point (APᵢ) backhaul can send traffic.

14. A method as per claim 13, comprising carrying out said estimation locally at said station (k).

15. A method as per claim 14, comprising estimating said utilization rate βᵢ by performing the next actions:
listening to the traffic sent by the access point (APᵢ) to any station, and storing the header MAC Sequence Numbers, or SNs, of the traffic frames or packets; and
counting the stored SNs to know the amount of packets traversing the access point (APᵢ) backhaul during a determined time.

16. A method as per claim 14, comprising performing said SNs counting by the next expression:
Nⁱ=(SN_{M}ⁱ[Last]−SN₁ⁱ[First])mod 4095
where SN_{M}ⁱ and SN₁ⁱ are, respectively, the MAC sequence number of the first and last packet sent by the access point (APᵢ) to any station, during a window of time M·T, where M is an integer equal or greater than 1, and mod 4095 is a 802.11 module 4095.

17. A method as per claim 16, comprising calculating said utilization rate as:
$${β}_{i} = \frac{E [ {L}_{i} ] \cdot {N}^{i}}{M \cdot T}$$
where E[Li] is the average bit length per packet at IP layer over all the packets received by the station (k) when it is connected to the access point (APᵢ)

18. A method as per claim 14, comprising estimating said wireless capacity ωᵢₖ by calculating the packet dispersion of frames directed to it when the access point (APᵢ) is transmitting in saturation.

19. A method as per claim 18, comprising, in order to detect saturation periods, the station (k) run-time sensing the wireless channel occupancy or percentage of time that the channel is busy, between two consecutive received packets, and if the occupancy is above a certain threshold, the method comprises defining the access point (APᵢ) as in saturation for that two consecutive packets and storing the packet length of the second packet and the dispersion between the packets.

20. A method as per claim 19, comprising estimating said wireless capacity ωᵢₖ by averaging it over a window of measure M·T as:
$${w}_{ik} = \frac{{\sum }_{j = 1}^{M} {B}_{j}}{{\sum }_{j = 1}^{M} {T}_{j , SAT}^{i}}$$
where Bⱼ is the sum of the packet length in saturation sent from the access point (APᵢ) to the station (k) and T_{j,SAT}ⁱ is the sum of the dispersions when the station (k) receives in saturation mode during the j-th connection to the access point (APᵢ).

21. A method as per claim 14, comprising estimating said backhaul capacity bᵢ by connecting, the single radio interface, to a capacity server and calculating the peak reached by the utilization rate βᵢ during the connection time to said capacity server as
$${b}_{i} = {max \overline{{β}_{i} [ l ]}}_{l = 1 , 2 , … L}$$
where L represents the number of measures during the test at the 1/(M·T) rate, and β̅ᵢ̅[̅l̅]̅ denotes the smoothed average of βᵢ[l] after the l-th calculation.

22. A method as per claim 4 when depending on claim 4, comprising virtualizing a wireless driver on top of the single radio interface such that it appears as independent Virtual STAtions, VSTAᵢ, associated to a respective of said access points (AP₁, AP₂, AP₃), and using each VSTAi as responsible for managing the data communication with the access point (APᵢ) and the related procedures, said duty cycle or corrected duty cycle fᵢₖ being calculated for the connection of each of said Virtual STAtions to a respective (APᵢ) of said access points (AP₁, AP₂, AP₃).

23. A single radio station for managing station throughputs from a wireless multiple access points backhaul, characterised in that it comprises processing means implementing algorithms for performing the scheduling and parameter estimation of the method as per any of the previous claims, and communicating means for connecting any station (k) to at least one access point (APᵢ) according to the obtained scheduling.
